(19) United States
(12) Patent Application Publication
(10) Pub. No.: US 2006/0288838 A1
(43) Pub. Date: Dec. 28, 2006

(54) Glass cutting table

(76) Inventor: Peter Lisec, Amstetten-Hausmening (AT)

Correspondence Address: YOUNG & THOMPSON, 745 SOUTH 23RD STREET, 2ND FLOOR, ARLINGTON, VA, 22202, US

(21) Appl. No.: 10/567,750

(22) PCT Filed: Aug. 11, 2003
(86) PCT No.: PCT/AT03/00230

§ 371 Date: Feb. 10, 2006

(51) Int. Cl. B26D 3/08; B26D 1/18

(52) U.S. Cl. 83/879; 83/483

(57) ABSTRACT

A glass cutting table (1) has a support in the form of a top (3) for the glass plate to be divided, furthermore a cutting bridge (4) which can be moved along the support, and on which a cutting head (6) with a cutting tool is located. The drive and guide unit (10) is located at a distance underneath the top (3) which forms the support of the glass cutting table (1) and is attached to the base frame (2) of the glass cutting table (1) independently of the top (3). In addition the guide and drive unit (10), which consists of guide rods (12) for the cutting bridge (4) and a gear-toothed belt drive (15, 16, 17) for moving the cutting bridge (4) relative to the outside contour of the top (3) of the glass cutting table (1), is offset to the inside to especially the lengthwise edges (5) of the top (3). Thus, the support of the glass cutting table (1) is easily accessible, there is no danger that the guide and drive unit (10) will be fouled or damaged by glass shards or the like, and for a top (3) which is made divided its part (30) which can be folded up can be tilted to accommodate glass plates to be divided, independently of the guide and drive unit (10).

The invention relates to a glass cutting table with the features of claim 1, with a support for the glass plate to be divided, with a cutting bridge which can be moved along the support and with a cutting head positioned to be able to move on the cutting bridge. The cutting head carries a tool, for example a cutting wheel, for scratching the glass plate along the dividing outline.

Such a glass cutting tables is known from JP 07089740 A. In this known glass cutting table the cutting bridge is guided by way of guides underneath the glass support plate. There is a common drive motor for the two toothed belts for moving the cutting bridge along the table. The guides and the drive of the cutting bridge form a unit with the support plate. Folding the support plate up is not provided.

FR 2 545 815 A shows a glass cutting table with a cutting bridge which can be moved into a position outside of the area of the support plate in order to be able to fold it up. The cutting bridge is guided on guides which have roughly the same vertical position as the support surface of the cutting table. One of the guides, specifically the one which is located in the area of the pivoting axle of the support plate, is divided.

In the known glass cutting tables the cutting bridge is guided on guide rods (for example, round rods) which are mounted in the vicinity of the support which is made as a table top for the glass plate to be divided. The drive for moving the cutting bridge is also mounted in the area of the support for the glass plate to be divided.

For moving the cutting bridge along the support, drives are known which have racks mounted in the area of the support for the glass plate to be divided, and pinions which mesh with the racks and which are rotationally driven on the cutting bridge. The problem in these drives is that the racks have tooth systems which point up, so that there is the danger that shattering glass parts will end up in the racks and damage their teeth so that precise movement of the cutting bridge is no longer possible. It has already been suggested that the racks be provided with covers. But in the area of the pinions which move along the racks these covers must be raised away from the racks.

Continuous toothed belts are also known as a drive for moving the cutting bridges.

The known cutting tables (compare FR 2 545 815 A) have the disadvantage that they are only poorly accessible, especially their support for the glass plate to be divided, since the drives and the guides for the cutting bridge are mounted on the edge of the support.

Another disadvantage of the known embodiments for the guide and the drives of the cutting bridges of glass cutting tables arises for glass cutting tables in which the table top for holding the glass plates to be divided can be tilted out of the horizontal position of use into an oblique position in which a glass plate to be divided is placed on the table top. In the known cutting tables the cutting bridge, the guides and the drives for the cutting bridge must be tilted at the same time; this necessitates considerable loads and correspondingly powerful drives.

It has also already been proposed (FR 2 545 815 A) that the table top be divided into a part which can be folded up and a part in which the cutting bridge is in the standby position; however this has the disadvantage that in this embodiment coupling devices are necessary for the guide rods which are then to be made split on the one hand and for the racks on the other hand.

Glass cutting tables of the two aforementioned designs are mentioned in EP 0 673 890 B and are described as disadvantageous. EP 0 673 890 B proposes a glass cutting table in which the guide rods on which the cutting bridge can moved are mounted on the base frame underneath the support plate. How the drive for moving the cutting bridge is made is not described in EP 0 673 890 B. EP 0 673 890 B uses arms which can be pivoted up from the support plate for supporting glass plates in order to avoid the disadvantages of glass cutting tables with a support plate made as a tilt table, but however tolerates the disadvantages of pivoting arms for lifting (placing) glass.

The object of the invention is to devise a glass cutting table of the initially mentioned type in which the drive and the guide for the cutting surface are improved.

This object is achieved primarily with a cutting table for glass plates which has the features of claim 1.

Preferred and advantageous embodiments of the version of the cutting table as claimed in the invention are the subject matter of the dependent claims.

Since in the cutting table as claimed in the invention the guides and the drives for the cutting bridge are arranged with a distance underneath the support, not only is the support (table top) easily accessible, but there is no longer any danger that the drive and/or the guide of the cutting bridge will be adversely affected or damaged by the glass fragments.

Another advantage consists in that the table top which is used as a support need be made less solid since it no longer has to be used to support the cutting bridge and the guides and the drive for the cutting bridge.

This has the advantage that in an embodiment in which the support or (only) part of the support (table top) can be tilted in order to hold glass plates, this part of the support can be made lighter so that less powerful drives are necessary in order to tilt this part of the table top which is used as a support for the glass plates which are to be divided. Then the problem in coupling of guides/drives when the tiltable part of the table top is folded back again is also eliminated.

Other details and features as well as advantages of the invention become apparent from the following description of one preferred embodiment using the drawings.

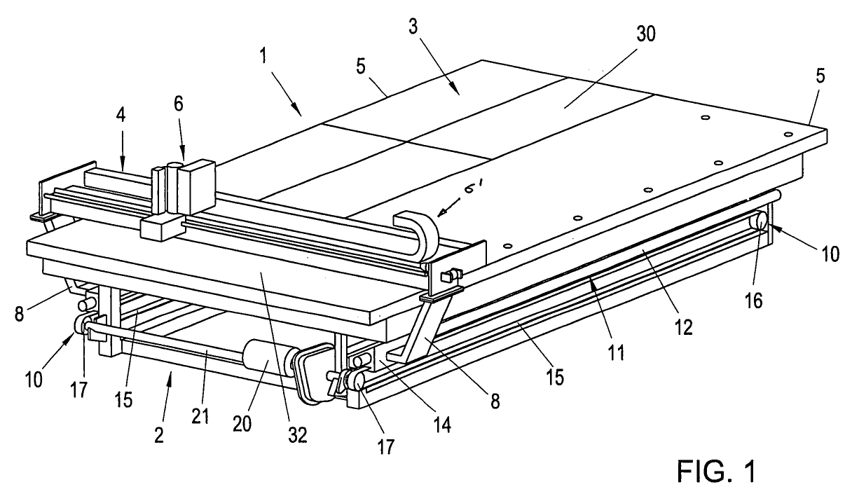

FIG. 1 shows in an oblique view a glass cutting table as claimed in the invention and

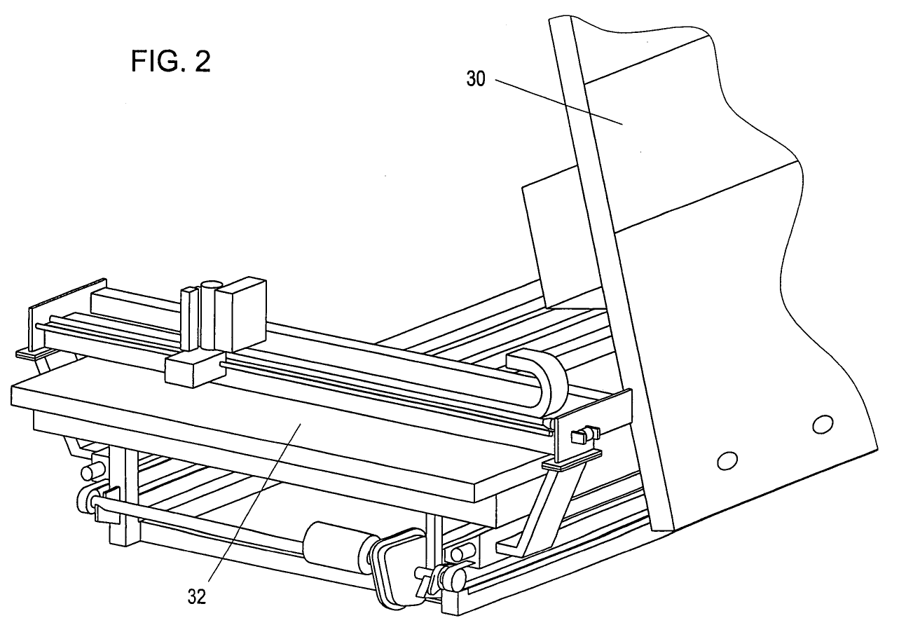

FIG. 2 shows the glass cutting table from FIG. 1 partially and on an enlarged scale with the folded-up part of the support.

The glass cutting table 1 which is shown in FIGS. 1 and 2 in an oblique view has a base frame 2 which is set up on a floor by way of feet which are not shown. The base frame 2 bears a top 3 (table top) which is used as a support for a glass plate which is to be divided (tape measures). The top 3 can be equipped with conveyor means which are not shown for moving and positioning the glass plate which is to be divided before and after cutting. Furthermore, the top 3 can have a felt support and it is possible to make the top 3 as an air cushion top, in which case in the top 3 it has air outlet openings arranged distributed according to a certain pattern for compressed air which is supplied to these openings so that between the top 3 which forms the support and a glass plate an air cushion can form which reduces the friction between the glass plate and the support 3.

The top 3 is generally made rectangular. There is a cutting bridge 4 aligned parallel to the shorter side of the top 3 which is used as a support. The cutting bridge 4 can be moved along the longer side 5 of the support 2. The cutting bridge 4 bears a cutting head 6 which can be moved along the cutting bridge 4 by a drive which is not detailed, generally a toothed belt drive for executing the actual cutting work. The cutting head 6 can be made as desired and usually bears a cutting wheel which can be turned in the cutting head 6 around an axis perpendicular to the support 2, and can be raised and lowered normally to the top 3, and to which a cutting liquid can be supplied. The cutting head 6 can also be made for simultaneous stripping and cutting (scratching) of the glass plates (compare EP 0 517 176 A). The power supply chain 6′ to the cutting head 6 is shown only partially in FIGS. 1 and 2.

The cutting bridge 4 is connected to the guide and drive units 10 which are located on the two lengthwise sides of the glass cutting table 1 by way of two arms 8 which project from top to bottom obliquely to the inside, i.e. to under the outside contour of the top 3, and which are attached to their ends.

The guide 11 for the cutting bridge 4 consists of two guide rods 12 (for example, round rods) which are attached to the base frame 2 and which are aligned parallel to the lengthwise sides 5 of the support top 3, and on which sliding blocks 14 which are attached to the arms 8 can be moved by sliding. The guides 11 for the cutting bridge 4 are attached to the base frame 2 at a distance under the top 3 and independently of it and are arranged offset to the center of the top 3 relative to the lengthwise sides 5 of the top 3 (for which reason the arms 8 of the cutting bridge 4 are also aligned obliquely.

In order to move the cutting bridge 4 along the top 3 of the glass cutting table 1, on the two lengthwise sides of the base frame 2, at a distance from and underneath the guide rods 12 for the cutting bridge 4, there are conveyor elements in the form of toothed belts 15. The toothed belts 15 run around freely rotating deflection rolls 16 and around gears 17 which are rotationally driven. For rotary driving of the gears 17 (in FIG. 1 the two gears located on the left) there is a common geared motor 20 which drives a shaft 21 which for its part drives the gears 17 without the interposition of other transmission means. Thus a drive (for the most part) free of play for moving the cutting bridge 4 along the support 3 of the table 1 when executing the “cutting” (scratching) of a glass plate is possible.

It is apparent that the drive and guide units 10 for the cutting bridge 4 are carried independently of the top 3 of the glass cutting table which is used as a support, specifically directly by the base frame 2.

For the embodiment shown in FIGS. 1 and 2, the top 3 which forms the support of the glass cutting table 1 as claimed in the invention is divided, specifically into a larger part 30 and into a narrower part 32. The narrower part 32 of the top 3 is rigidly connected to the base frame 2 and forms an area in which the cutting bridge 4 is in its standby position. The other, larger part 30 of the top 3, as shown in FIG. 2, can be tilted around an axis which is aligned parallel to the lengthwise edge 5 of the top 3 (longer side) in order to take up a glass plate from a glass store or from a lifting crane.

It is apparent that the top 3 of the cutting table 1 as claimed in the invention is not used to carry the guides and/or drives for the cutting bridge 4 so that it can be made lightweight because it need not bear the weight of the guide/drive unit 10 for the cutting bridge 4 either. It also has the advantage that when tilted, the cutting bridge 4 and its drives and guides 10 need not be moved at the same time.

Due to the arrangement of the guide and drive unit 10 of the glass cutting table 1 as claimed in the invention at a distance below the support 2 and relative to the top 3 thereof offset to the inside, there is no danger than the drive and/or guide units 10 for the cutting bridge 4 will be adversely affected or damaged by glass shards or the like.

The execution of the glass cutting table 1 as claimed in the invention, especially the embodiment which is shown in the drawings, has the advantage that the support top 3 is easily accessible, since the guides/drives 10 for the cutting bridge 4 are not next to it, since they are arranged or mounted relative to the outside contour of the top 3 offset to the inside on the machine frame 2, therefore underneath the support plate 2 and independently of it.

In the device as claimed in the invention, in one preferred embodiment the guide of the cutting bridge 4 (especially the guide rods 12) and/or the drive of the cutting bridge (especially the continuous conveyor elements 12) is mounted independently of a folding support 3 of the glass cutting table, for example mounted/supported on the machine frame 2. In particular, the entire guide and drive unit 10 is mounted for example on the base frame 2 independently of the support 3.

In one embodiment the cutting bridge (4) can be moved into a standby position outside of the top 3 which can be folded up. In the standby position under the cutting bridge 4 there is no fixed part of the top 3 which forms the support for the glass.

In summary one embodiment of the invention can be described as follows:

A glass cutting table 1 has a support in the form of a top 3 for the glass plate which is to be divided, furthermore a cutting bridge 4 which can be moved along the support and on which the cutting head 6 with a cutting tool is located with an adjustment capacity.

The drive and guide unit 10 for the cutting bridge 4 is located at a distance underneath the top 3 which forms the support of the glass cutting table 1 and is mounted on the base frame 2 of the glass cutting table 1 independently of the top 3. In addition, the guide and drive unit 10, which consists of guide rods 12 for the cutting bridge 4 and a gear-toothed belt drive 15, 16, 17 for moving the cutting bridge 4 relative to the outside contour of the top 3 of the glass cutting table 1, is offset to the inside especially to the lengthwise edges 5 of the top 3. Thus, the support of the glass cutting table 1 is easily accessible, there is no danger that the guide and drive unit 10 will be fouled or damaged by glass shards or the like, and for a top 3 which is made divided its part 30 which can be folded up can be tilted to accommodate glass plates to be divided, independently of the guide and drive unit 10.

1-14. (canceled)

15. Glass cutting table (1) with a top (3) which is used as a support for the glass plate to be divided, with a base frame (2), with a cutting bridge (4) which can be moved along the top (3), and with a cutting head (6) which can be moved on the cutting bridge (4), the cutting bridge (4) being guided on guides (12) which are located underneath the top (3), and continuous conveyor elements (15) which are located likewise underneath the top (3) for moving the cutting bridge (4) along the top (3) being assigned to the ends of the cutting bridge (4), characterized in that the top (3) which is used as a support is mounted on the base frame (2) with a capacity to be folded up, that the guides (12) and the continuous conveyor elements (15) are mounted on the base frame (2) independently of the top (3) which can be folded up and that the cutting bridge (4) can be moved into a position outside of the top (3) which can be folded up.

16. Table as claimed in claim 15, wherein the guide rails (12) for the cutting bridge (4) are arranged offset to the inside relative to the outside edges (5) of the support (3), especially the edges (5) of the latter which run along the lengthwise side.

17. Table as claimed in claim 15, wherein the cutting bridges (4) are connected to guide shoes (14) which have been placed on the guides (12) by way of connecting pieces (8) which are pointed from top to bottom obliquely to the inside.

18. Table as claimed in claim 15, wherein there is a common drive motor (20) for the driving of the continuous conveyor elements (12).

19. Table as claimed in claim 18, wherein the drive motor (20) drives a shaft (21) which is assigned to the two continuous conveyor elements (12) as drive means.

20. Table as claimed in claim 19, wherein the continuous conveyor elements are toothed belts (12) and wherein gears (17) which mesh with the toothed belts (12) are mounted on the common drive shaft (21).

21. Table as claimed in claim 15, wherein the top (3) is subdivided at least once, a preferably smaller section (32) of the top (3) forming an area in which the cutting bridge (4) is located in its standby position, and wherein the other, preferably larger part (30) of the top (3) can be folded up to hold the glass plates.

22. Table as claimed in claim 21, wherein the foldable part (30) of the top (3) can be pivoted around an axis which is aligned parallel to the displacement direction of the cutting bridge (4), therefore normal to the cutting bridge (4).

23. Table as claimed in claim 15, wherein the guides (12) for the cutting bridge (4) are aligned transversely to the lengthwise extension of the cutting bridge (4).

24. Table as claimed in claim 15, wherein the guides (12) for the cutting bridge (4) are guide rails or rods which are mounted on the base frame of the cutting table.

25. Table as claimed in claim 15, wherein the drive rolls (17) and the deflection rolls (16) for the continuous elements (12), especially the toothed belts, are supported on the base frame (2).

26. Table as claimed in claim 15, wherein the drive motor (20) for the continuous elements (11) is mounted on the base frame (2).

27. Table as claimed in claim 15, wherein the drive shaft (21) for the two continuous elements (12) is pivotally supported in the base frame (2).
